(19) United States
(12) Patent Application Publication
(10) Pub. No.: US 2017/0206983 A1
(43) Pub. Date: Jul. 20, 2017

(54) METHOD AND FUEL DESIGN TO STABILIZE BOILING WATER REACTORS

(71) Applicant: YOUSEF M. FARAWILA, RICHLAND, WA (US)

(72) Inventor: YOUSEF M. FARAWILA, RICHLAND, WA (US)

(21) Appl. No.: 14/997,557

(22) Filed: Jan. 17, 2016

(51) Int. Cl. G21C 3/04; G21C 3/32; G21C 3/60; G21C 3/07

(52) U.S. Cl. CPC G21C 3/04; G21C 3/07; G21C 3/32; G21C 3/60; G21Y 2002/104; G21Y 2004/30

(57) ABSTRACT

A method of stabilizing density wave oscillations in boiling water reactor cores is disclosed. The invention introduced a thin metallic fuel element made of fissile isotope baring metal encased and bonded with metallic cladding. The thin construction and the metallic material guarantee very short thermal time constant compared with the oscillation period. Although the feedback of the processes involved in density waves are negative, i.e. oppose any initial perturbation, sufficiently strong feedback may result in unstable behavior because of the time delay inherent in the propagation of the density wave and the heat conduction delay in the traditional fuel rods made of ceramic pellets encased in zircaloy tubes. The new fuel element of this invention introduces fast, not delayed, thermal energy to the coolant in response of any neutron flux perturbation, and thus introduces a stabilizing feedback. Boiling water reactor fuel bundles may benefit from this invention by including the new fuel element as part of its array of fuel rods, preferably filling in the space vacated by part-length fuel rods.

### FIELD OF THE INVENTION

This invention relates to boiling water reactors (BWR). More specifically, a new method and fuel design are disclosed for stabilizing the density wave oscillations in BWR cores. The use of the disclosed fuel prevents the development of diverging flow and power oscillations that threaten fuel integrity.

### BACKGROUND OF THE INVENTION

Boiling Water Reactors generate electric power using nuclear fission as a heat source. Thermal power is generated in the reactor core which is placed inside a large pressure vessel. The reactor core is made up of a plurality of fuel assemblies also called fuel bundles. A fuel bundle is made of fuel rods that are arranged in a regular array inside a vertical channel of square cross section through which water coolant is injected from the bottom. The said rods are sealed cylindrical tubes inside which ceramic pellets of fissionable material, e.g. Uranium oxide, are stacked. The fuel rod tubes, also called cladding, and the outer channel encasing each fuel assembly, are made of a low neutron absorbing metal such as Zirconium-based alloys.

The water flows upward in the fuel channels and removes the heat generated in the pellets by the fission of the uranium and plutonium nuclei. In addition to its cooling function, the water serves as neutron moderator. The neutron moderation function is achieved as the neutrons produced in the fission process collide with the hydrogen atoms in the water molecules and slow down to lower energies which increase the probability of inducing further fission reactions.

In Boiling Water Reactors, the water coolant is allowed to boil as it travels up in each fuel assembly channel. The density of the coolant is reduced by the boiling process and consequently the moderating function is adversely affected particularly in the upper part of the fuel assembly where the fuel-to-moderator ratio becomes higher than optimally desired. This problem was mitigated in some fuel assembly designs by introducing one or more water rods or channels, henceforth called water channels. A water channel is a hollow tube or conduit extending vertically along the fuel rods, and through which part of the water flows without boiling. Thus, the amount of water available for the neutron moderating function is increased. Another common improvement in the design of fuel assemblies is the use of part-length fuel rods. While the typical active length of a full-length fuel rod is 3.8 m, few short rods in selected array positions are used. The length of a part-length rod is typically half to two-thirds that of the full length rod, and there are typically 8 to 12 part-length rods in each assembly. The space vacated by cutting down the length of some rods is filled with voided coolant (steam-water mixture) flow, and therefore restores the fuel-to-moderator ratio in the top part of the fuel assembly closer to the optimum value for nuclear criticality management. The use of part-length fuel rods is also beneficial in reducing the flow resistance in the top part of the assembly as the flow area is increased. However, the use of part-length rods comes at the expense of the amount of fissionable material that can be packed into a fuel assembly.

The reactor core is made of a number of parallel, nuclear-heated, boiling channels. The core is supported at the bottom with the so-called core support plate, where each of the fuel assembly is seated on a flow opening called inlet orifice. The inlet orifices restrict the flow into each fuel assembly and serve to distribute the total flow into the core evenly among individual fuel assemblies. The core support structure allows for water leakage into the space between the fuel channels forming the so-called bypass flow. The core is encased in a cylindrical shroud which separates the upward flow inside the core and the bypass from the downward flow in the downcomer, where the latter is the annulus space between the core shroud and the pressure vessel wall.

Detailed description of BWR design and operation can be found in Ref. (1) R. T. Lahey, Jr., and F. J. Moody, “The Thermal-Hydraulics of a Boiling Water Reactor,” 2^{nd} Edition 1993, American Nuclear Society, ISBN: 0-89448-037-5.

### Fission Energy Distribution

Thermal power is generated in the reactor core due to sustained fission reactions. In response to an incident neutron a U235 nucleus is split into two lighter nuclei and two or three neutrons. Large amount of energy, nearly 200 MeV, is released per fission reaction and is mostly carried as kinetic energy of the two fission product nuclei. The remaining energy is carried by gamma rays and the fission neutrons. Fission energy carried off by neutrinos are not recoverable. The energetic fission neutrons deposit most of their kinetic energy in collisions with the solid structure but most of their energy is deposited by collisions with hydrogen nuclei in the water coolant. That is why the coolant is said to act also as neutron moderator because of its role in slowing down the neutrons and bring their energy down thus increasing the probability of absorption with uranium nuclei thus completing the fission chain reaction cycle. Gamma rays are also absorbed in the solid structures, fuel and cladding and assembly channel, but a considerable fraction is absorbed in the coolant water. The fission product nuclei are relatively heavy and they deposit their kinetic energy after a very short travel distance thus depositing all their energy in the uranium oxide pellets. In essence, most of the fission energy to the amount of 97.5% is carried by the fission product nuclei and is deposited locally in the uranium oxide pellets, while the remaining 2.5% is deposited in the water coolant which absorbs some of the gamma rays and absorbs kinetic energy carried by neutrons. The latter 2.5% fraction is referred to as the direct energy deposition fraction. The energy deposited in the fuel pellets must be transported by heat conduction through the pellet and cladding wall before reaching the coolant are therefore called the indirect heating component.

### Reactor Stability

Coolant flow and core power instabilities must be avoided for safe and smooth operation of the BWR plant. The reactor operation is stable under normal operating conditions, but can depart from stable configuration at conditions of typically high power combined with low flow. The nature of the instability is outlined below.

The unstable behavior in a BWR is associated with the density waves in vertical boiling channels such as BWR fuel assemblies. Pure thermal-hydraulic density wave oscillation can be excited under the idealized conditions of constant pressure drop across the boiling channel and constant rate of heat addition to the coolant. In the case of a random perturbation to the flow rate at the inlet of the channel, while the energy transfer rate to the coolant remains unchanged, a corresponding enthalpy wave travels upward with the flow. Downstream from the elevation of boiling inception, the change of enthalpy is translated to a steam quality wave where more steam is generated per unit of flow rate to account for an enthalpy increase. The void fraction (by volume), defined as the ratio of the steam volume to the total volume, is generally proportional to the steam quality, and therefore a void fraction wave traveling up the boiling channel results from the originating inlet flow perturbation. Because void fraction is inversely proportional to the fluid density, a propagating void fraction wave is equivalent to a propagating density wave, hence the basic phenomenon is named “density wave oscillations.” All flow parameters, mainly flow rate and steam quality and void fraction, are subsequently perturbed and the perturbations travel upward in the boiling channel with a phase lag.

The density wave alters the flow characteristics in two ways. The first one is that the total weight of the coolant in the channel, which is proportional to the integrated density along the channel, is altered dynamically resulting in a net gravitational pressure head response. The second way is the change in friction pressure drop along the channel. The friction pressure drop in turn is affected in two ways: the first way is through the change in the flow rate itself (friction being proportional to the square of flow rate), and the second way through the change in the so-called two-phase multiplier which accounts for the increase in frictional pressure drop for higher steam quality. In an idealized situation, the net pressure drop across the channel is kept constant, which leaves a residual component of force to compensate for the driving changes in density head and the changes in friction. The net force accelerates the flow, which reinforces an original flow perturbation of the so-called resonant frequency leading to the potential growth of the oscillation. It is important to notice that the feedback effects are negative in the sense that an inlet flow perturbation generates a force that tend to oppose the perturbation, however this negative feedback is delayed as consequence of the wave propagating at finite speed. There is a frequency at which the negative but delayed feedback leads to oscillatory instability when the magnitude of the feedback (gain) is sufficiently strong. The feedback gain is increased when the inlet subcooling is increased (lower inlet flow temperature), power-to-flow ratio is increased, and when the axial distribution of the power is more bottom skewed (more energy delivered to the bottom part of the channel than to the top).

In a BWR, the density waves are coupled to the neutronic reactivity. The coolant density oscillations result in a corresponding neutron moderation effectiveness which in turn result in nuclear reactivity and fission power response. The majority of fission energy generated inside the fuel rods is transferred to the coolant through heat conduction in the fuel rods through the clad surface. The fluctuation of the heat flux through the clad surface is filtered through the heat conduction processes through the fuel rods and the clad surface heat flux experiences a damped and delayed response relative to the fission power itself. The time lag of the heat flux relative to the energy generated in the fuel pellets is significant due to the fact that the fuel rod conduction time constant is large (in the order of 3 to 5 seconds approximately depending on the particular design and dimensions of the fuel rod). The fluctuation of the heat flux results in corresponding fluctuations in the boiling rate and the coolant density where such feedback tends to further destabilize the density waves in the boiling channels. By contrast, the component of the fission energy that is deposited directly in the coolant (absorption of gamma rays and neutron slowing down) constitute another feedback loop that is also negative but not delayed and therefore has a stabilizing effect. The fraction of fission energy in the form of gamma rays and neutron kinetic energy is a property of nature that cannot be artificially manipulated and increased in order to benefit from its density wave stabilizing effect.

The operation of BWR under oscillating conditions is not permitted by the Nuclear Regulatory Commission (NRC) in the US or its equivalent authorities in foreign countries. This restriction is placed in order to avoid violating the thermal limits in the fuel, potentially resulting in fuel damage.

A detailed report on density wave instabilities and oscillations in BWR's can be found in Ref. (2) J. March-Leuba, “Density-Wave Instabilities in Boiling Water Reactors,” Oak Ridge National Laboratory ORNL/TM-12130 NUREG/CR-6003, September 1992.

### Plutonium Disposition

Fissile plutonium isotope Pu239 is a product of spent fuel reprocessing and quantities of it is a surplus of dismantled weapon programs. The prior art for using and disposition of plutonium is mixing plutonium and uranium oxides to make mixed oxide (MOX) which can be used as fuel for light water reactors.

### SUMMARY OF THE INVENTION

The INVENTION is a new method for stabilizing the reactivity-coupled density wave oscillations in BWR cores. The method prescribes increasing the fraction of the energy deposited in the coolant on a very short time scale which mimics the effect of the direct energy deposition from gamma ray absorption and neutron slowing down. The method is embodied in thin metallic fuel elements where the fission energy, including the fission product nuclei kinetic energy, is transferred to the coolant through heat conduction with insignificant delay. The key to the success of this method is the design of the fuel properties such that its thin construction and the high thermal conductivity of the material combine to make the heat conduction time constant less than half an oscillation period. With density wave oscillation period typically in the range of 1.5 to 3 seconds, the conduction time constant of the new fuel element that is less than 0.5 seconds is sufficient to achieve significant stabilization. A small fraction of the thermal energy generated in the BWR core is generated in the thin metallic fuel elements, which is sufficient to augment the direct energy deposition component to stabilize the reactor, while the core performance in other aspects remains largely unchanged.

The thin metallic fuel elements can be made using uranium or plutonium. Mixture of plutonium and uranium metals can be also used. Metal alloys containing fissile uranium and or plutonium are suitable for realizing this invention. The use of plutonium to make the metallic fuel elements of this invention serves the combined functions of stabilizing boiling water reactors and also provide means for safe plutonium disposition.

### BRIEF DESCRIPTION OF THE FIGURES

The foregoing and other features and advantages of the present invention will become more readily appreciated as the same become better understood by reference to the following detailed description of the preferred embodiments of the invention when taken in conjunction with the accompanying drawings, wherein:

FIG. 1 illustrates the preferred embodiment fuel element (100) showing the cross section which is a star or a union jack shape. The inner material (101) is made of fissile isotope containing metal. The outer part (102) is metallic cladding.

FIG. 2 is 3-D representation of the fuel element (100) for which FIG. 1 is a cross section.

FIG. 3 is a variant of the metallic fuel element shown in FIG. 2, where the cross section of the fuel element (200) is x-shaped.

FIG. 4 is a sketch representation of part of a fuel bundle showing fuel rods (300) arranged in a regular lattice. The fuel element (100) which is an embodiment of this invention is shown in a lattice position. Other embodiments of thin metallic elements are shown where each fuel elements is placed in a lattice position: fuel element (110) is made of a group of 9 small metallic rods, fuel element (120) is made of 8 small metallic rods, and fuel element (130) is made of 7 small metallic rods.

FIG. 5 shows the cross section of fuel bundle (400) where fuel rods (300) are arranged in a regular lattice, thin metal fuel element (140) in the shape of a thin metal strip is placed to substitute 2 fuel rods.

FIG. 6 shows the cross section of fuel bundle (500) where fuel rods (300) are arranged in a regular lattice, rods (310) are shifted by half lattice period to create gap (320) where thin metal fuel element (140) in the shape of a thin metal strip is placed.

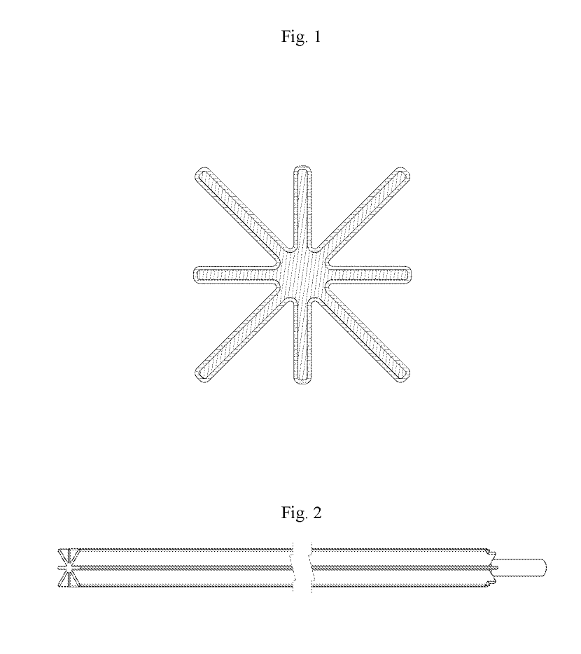

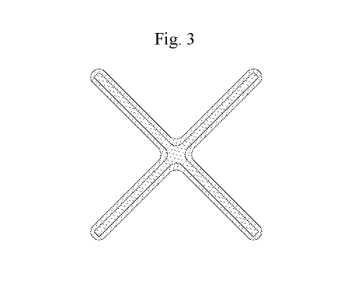

### DETAILED DESCRIPTION OF THE INVENTION

The patents and publications referred to herein are provided herewith in an Information Disclosure Statement in accordance with 37 CFR 1.97.

The Invention is a method for stabilizing the reactivity coupled mode of density wave oscillations in BWR. The structure of the embodiment of this method is a fuel element characterized with fast thermal response. The new fuel elements constitute a part of the fuel bundle of traditional design and produce a small percentage of power relative to the total bundle power that is comparable to the percentage of fission energy deposited directly in the active coolant via gamma ray absorption and neutron slowing down. The new fuel element mimics the stabilizing effect of the direct energy deposition as it releases power to the coolant in direct proportion to the neutron flux and the energy release occurs nearly instantaneously. The heat conduction time constant in the new fuel element should be significantly less than the oscillation period to achieve the desired stabilizing effect.

The simplest embodiment of the new fuel element is made of a thin strip of fissile plutonium-zirconium or uranium-zirconium alloy with a cladding layer of Zircaloy. The total thickness of the strip is in the order of 1-3 mm (approximately), for which the conduction time constant is of the order of a tenth of a second, which is sufficient to satisfy the fast thermal response requirement. A union-jack or cruciform cross section of the fuel element is preferred for its mechanical strength and for providing more surface area compared with a metal strip. Other embodiments include making a fuel element of small rods or wires where each rod is made of fissile-containing metal alloy covered with an outer layer of metal cladding. The fuel element made of small metal rods may contain 7 or 8 or 9 or as may be suitable for designing the needed fissile mass and fuel element surface area and the heat conduction time constant. Several of the new fuel elements of the preferred or other embodiments are placed in a fuel bundle of any existing design to substitute some of the fuel rods. The new fuel elements preferred positioning is in fuel bundle lattice positions vacated by part-length rods. The new fuel element can be optionally attached to the top of the part-length rods. For a fuel bundle design with, for example, 12 part-length rods there is room for 12 new fuel elements. The maximum length of the new fuel element equals the length of the full-length fuel rod minus that of a part-length rod. The actual length of the new fuel element and the number of array positions to be used can be varied as design parameters subject to overall optimization of the fuel bundle. The alloy concentration and enrichment of the fissile material in the new fuel element can be also varied by a fuel designer. The preferred base metal used in alloying to make the fissile core of the new fuel elements is zirconium, but other materials can be used in general as long as they satisfy requirements of mechanical strength and chemical compatibility and low neutron absorption.

Embodiments and obvious variants of methods of stabilizing and of fuel rod configurations include the following:

1. A method for introducing a damping effect to stabilize neutron-reactivity-coupled density wave flow and power oscillations in a boiling water reactor core comprising the introduction into at least one fuel bundle of at least one thin fuel element, bearing a fissile isotope, by which a flow perturbation which in turn creates a proportional neutron flux perturbation produces fast power response in the coolant which opposes the original perturbation thus stabilizing the reactor. The fissionable material is in at least one thin fuel element and is natural uranium or uranium enriched in the isotope U-235 alloyed with zirconium. Alternatively, the fissionable material, in at least one thin fuel element, contains the fissile isotope plutonium-239.

2. A nuclear fuel element in the shape of a rod with rectangular cross section of small thickness in the order of 1 to 3 mm such that its thermal time constant is in the order of less than 500 ms, further comprised of a zirconium alloy cladding bonded to core metallic alloy bearing fissile isotope and completely encasing it. An embodiment has a cross section of the fuel element which is cruciform. An alternative and obvious variant is a cross section of the fuel element which is multi-flanged shape such as a star or a union jack.

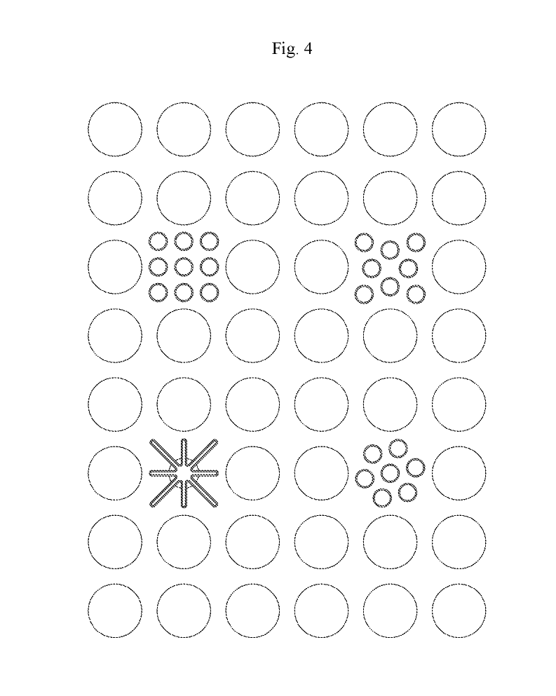

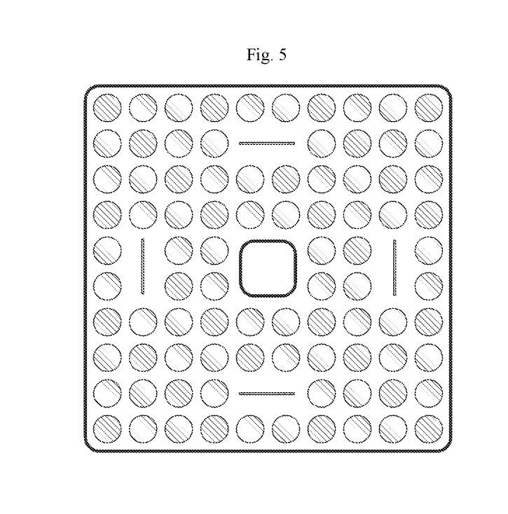

3. A variant fuel element nuclear is comprised of a plurality of small rods or wires where each of the said small rods is made of metallic alloy bearing fissile material and encased in metallic cladding. The nuclear fuel element is may be made of 7 or 8 or 9 small rods as shown in FIG. 4.

4. A variant nuclear fuel bundle may comprise or be composed of fuel rods made of tubes filled with uranium oxide pellets which are placed in a regular lattice, further having some of the said fuel rods replaced by metallic fuel elements. Alternatively, the metallic fuel elements will be of a reduced length compared to other fuel rods or the metallic fuel elements can be attached to part length fuel rods.

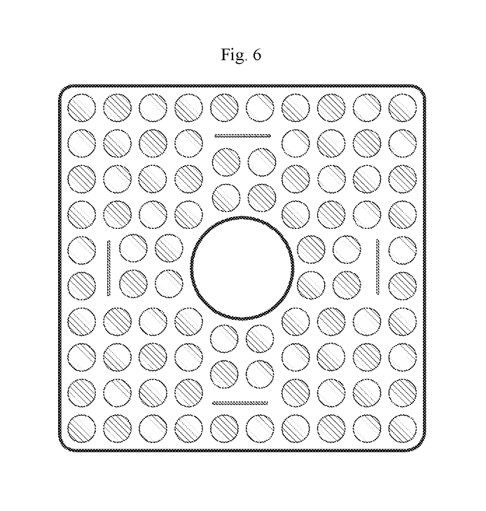

5. Another embodiment will be a nuclear fuel bundle where fuel rods are placed in a regular lattice, further having some rod positions shifted by half lattice period thus creating widened spaces between rods; said wide spaces occupied by thin metallic fuel elements as shown in FIG. 6.

1. An (invention) comprising: method for introducing a damping effect to stabilize neutron-reactivity-coupled density wave flow and power oscillations in a boiling water reactor core comprising the introduction into at least one fuel bundle of at least one thin fuel element, bearing a fissile isotope, by which a flow perturbation which in turn creates a proportional neutron flux perturbation produces fast power response in the coolant which opposes the original perturbation thus stabilizing the reactor.

2. An (invention) . . . depending from claim 1 and further comprising: the fissionable material, in the at least one thin fuel element, is natural uranium or uranium enriched in the isotope U-235 alloyed with zirconium.

3. An (invention) . . . depending from claim 1 and further comprising: the fissionable material, in at least one thin fuel element, contains the fissile isotope plutonium-239.

4. An (invention) comprising: a nuclear fuel element in the shape of a rod with rectangular cross section of small thickness in the order of 1 to 3 mm such that its thermal time constant is in the order of less than 500 ms, further comprised of a zirconium alloy cladding bonded to core metallic alloy bearing fissile isotope and completely encasing it.

5. An (invention) . . . depending from claim 4 and further comprising: the cross section of the fuel element is cruciform.

6. An (invention) . . . depending from claim 4 and further comprising: the cross section of the fuel element is multi-flanged shape such as a star or a union jack.

7. An (invention) comprising: a nuclear fuel element made of a plurality of small rods or wires where each of the said small rods is made of metallic alloy bearing fissile material and encased in metallic cladding.

8. An (invention) . . . depending from claim 7 and further comprising: the nuclear fuel element is made of 7 or 8 or 9 small rods as shown in FIG. 4.

9. An (invention) comprising: a nuclear fuel bundle where fuel rods made of tubes filled with uranium oxide pellets are placed in a regular lattice, further having some of the said fuel rods replaced by metallic fuel elements.

10. An (invention) . . . depending from claim 8 and further comprising: the metallic fuel elements are of a reduced length compared to other fuel rods.

11. An (invention) . . . depending from claim 8 and further comprising: the metallic fuel elements are attached to part length fuel rods.

12. An (invention) comprising: a nuclear fuel bundle where fuel rods are placed in a regular lattice, further having some rod positions shifted by half lattice period thus creating widened spaces between rods; said wide spaces occupied by thin metallic fuel elements as shown in FIG. 6
